(19) United States
(12) Patent Application Publication
(10) Pub. No.: US 2019/0356815 A1
(43) Pub. Date: Nov. 21, 2019

(54) IMAGE PROCESSING APPARATUS AND CONTROL PROGRAM FOR IMAGE PROCESSING APPARATUS

(71) Applicant: KONICA MINOLTA, INC., Tokyo (JP)

(72) Inventor: Hiroaki KUBO, Muko-shi (JP)

(73) Assignee: KONICA MINOLTA, INC., Tokyo (JP)

(21) Appl. No.: 16/408,867

(22) Filed: May 10, 2019

(30) Foreign Application Priority Data
May 21, 2018 (JP) 2018-096984

(51) Int. Cl. H04N 1/393; G06T 5/20

(52) U.S. Cl. CPC H04N 1/393; G06T 5/20

(57) ABSTRACT

An image processing apparatus includes: a receiver that receives image data; a magnification changer that generates each of a plurality of magnification-changed images by magnifying the image data at a plurality of magnifications different from each other; a detector that detects a specific image from the plurality of magnification-changed images; and a hardware processor that restricts printing of the image data under a part of printing conditions in a case where the specific image is detected by the detector.

The entire disclosure of Japanese patent Application No. 2018-096984, filed on May 21, 2018, is incorporated herein by reference in its entirety.

### BACKGROUND

### Technological Field

The present invention relates to an image processing apparatus and a control program for an image processing apparatus. More specifically, the present invention relates to an image processing apparatus and a control program for an image processing apparatus in which detection accuracy can be improved while reducing consumption of a memory that stores image data.

### Description of the Related Art

Due to recent improvement in performance of an image reading apparatus and a color printer, there is a high risk that a document such as a banknote or a negotiable instrument (hereinafter may be referred to as a special document) relative to which copying is forbidden is forged by copying. JP 2001-144941 A, JP 2001-144940 A, and JP 2000-232578 A, and the like propose technologies that restrict printing of an image in order to prevent forgery of a special document in a case where a specific image is detected in the image included in the special document.

JP 2001-144940 A discloses the technology in which a coincidence degree is determined by comparing specific image data with image data read by a forgery determination module of a scanner driver, and a forgery prevention control module controls, based on the determination result, predetermined image processing for the image data read by the scanner driver.

JP 2001-144941 A discloses the technology in which a coincidence degree is determined by comparing specific image data with image data obtained by applying magnification change at a constant magnification to image data read by a forgery determination module of a scanner driver in accordance with a preset magnification for magnification change, and a forgery prevention control module controls, based on the determination result, predetermined image processing for the image data read by the scanner driver.

JP 2000-232578 A discloses a technology in which in a case where a magnification of digital image data received in a digital image receiver is changed, inverse magnification change processing to return the magnification of the digital image data to an equal magnification is performed in a magnification change processor, and a magnification of digital image data of an image to be output is made to the equal magnification. A pattern comparator determines whether the digital image data of the image to be output coincides with pattern data of an image of a special document preliminarily registered in a pattern registration device. In a case of determining that the digital image data to be output coincides with the image data of the special document, a digital image output device outputs an output image by performing forgery prevention processing for the output image.

FIGS. 20 and 21 are block diagrams illustrating specific image detection processing performed by respective image forming apparatuses in the related art.

Referring to FIG. 20, in a case of processing high-resolution image data, specific image detection processing is performed in the following order in order to reduce a size of the image data. When a print job execution command is received, a raster image processor (RIP) 111 generates raster data of image data by performing RIP processing for the image data to be printed. A binarizer 112a binarizes the generated raster data. The binarized data is stored in a memory (print image memory) 113.

Next, after receipt of the print job execution command, an editor 114 converts the binarized data into print data (data to be finally output) in accordance with edit operation (additional edit operation relative to the job) such as magnification editing (here, reduction to 50%) or layout editing (here, page allocation: 4 in 1) received from a user.

A detection resolution converter 115 converts a resolution of the print data to a resolution suitable for specific image detection processing. The data subjected to the resolution conversion is temporarily stored in a processing block buffer 116. A detection processing circuit 117 performs the specific image detection processing for the data stored in the processing block buffer. The detection processing circuit 117 performs the specific image detection processing by comparing the held specific image with the data stored in the processing block buffer.

In a case of detecting the specific image, the detection processing circuit 117 requests a printer 110 to cancel printing. The printer 110 cancels printing of the print data. On the other hand, in a case where the detection processing circuit 117 does not detect any specific image, the printer 110 normally prints the print data.

In the above-described processing, consumption of the memory 113 can be reduced because the binarized data is stored in the memory 113. However, in the above-described processing, there is a problem that detection accuracy of the specific image is degraded because detection of the specific image is performed for the binarized data.

To detect the specific image from data before binarization, it is possible to conceive a method of performing binarization processing by the binarizer immediately before printing by the printer 110 (that is, a method of using a binarizer 112b instead of a binarizer 112a in FIG. 20). However, in this method, there is a problem that consumption of the memory 113 becomes large because large-size data before binarization is stored in the memory 113.

Therefore, a method described below may be conceivable as a method of detecting the specific image from the image data before binarization while reducing the consumption of the memory 113.

Referring to FIG. 21, when a print job execution command is received, the RIP 111 generates raster data of image data by performing the RIP processing for the image data to be printed. The binarizer 112 binarizes the generated raster data. The binarized data is temporarily stored in the memory 113.

In parallel with the binarization processing, a color converter 118 performs, for the raster data of the image data, color conversion processing to separate only a color of the specific image from the raster data. A magnification converter 119 converts the data subjected to the color conversion into data having a magnification set by the print job under the control of a central processing unit (CPU) (print control CPU) 120. The detection resolution converter 115 converts the data subjected to the magnification conversion into data having a resolution suitable for detecting the specific image. The data subjected to the resolution conversion is temporarily stored in a processing block buffer 116. The detection processing circuit 117 detects the specific image from the data stored in the processing block buffer.

In a case of detecting the specific image, the detection processing circuit 117 requests the printer 110 to cancel printing. The printer 110 cancels printing of the print data. On the other hand, in a case where the detection processing circuit 117 does not detect any specific image, the printer 110 normally prints the print data.

Additionally, in a case of detecting the specific image, the detection processing circuit 117 requests the binarizer 112 to discard the data. In this case, the binarizer 112 discards the data, the binarized data is not stored in the memory 113, and printing is canceled. On the other hand, in a case where the detection processing circuit 117 does not detect the specific image, the binarized data is normally stored in the memory 113.

Next, the editor 114 converts the binarized data into print data (data to be finally output) in accordance with additional edit operation relative to the job received from the user under the control of the CPU 120. The printer 110 prints the print data.

In the above-described processing, there is a problem that detection accuracy of the specific image is degraded because the specific image is detected before receiving the additional edit operation relative to the job from the user.

In other words, in a case where image data to be printed by the job is image data in which a special document is magnified D times (D is an arbitrary number), the specific image included in the image data also becomes an image in which an original specific image is magnified D times. As a result, the specific image held by the detection processing circuit 117 does not coincide with the specific image included in the image data, and the detection processing circuit 117 does not detect the specific image from the image data. Therefore, in a case where the user performs the additional edit operation to change the magnification of the image data 1/D times (that is, in a case of returning the magnification of the image data to the magnification of the original special document), printing of the special document cannot be stopped, and a printed matter of the special document is output from the printer 110.

### SUMMARY

The present invention is made to solve the above-described problems and is directed to providing an image processing apparatus and a control program for an image processing apparatus in which detection accuracy can be improved while reducing consumption of a memory that stores image data.

To achieve the abovementioned object, according to an aspect of the present invention, an image processing apparatus reflecting one aspect of the present invention comprises: a receiver that receives image data; a magnification changer that generates each of a plurality of magnification-changed images by magnifying the image data at a plurality of magnifications different from each other; a detector that detects a specific image from the plurality of magnification-changed images; and a hardware processor that restricts printing of the image data under a part of printing conditions in a case where the specific image is detected by the detector.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a perspective view illustrating an image forming apparatus according to a first embodiment of the present invention;

FIG. 2 is a block diagram illustrating components of the image forming apparatus according to the first embodiment of the present invention;

FIG. 3 is a block diagram illustrating operation in which the image forming apparatus detects a specific image in the first embodiment of the present invention;

FIGS. 4A to 4F are diagrams schematically illustrating a plurality of magnification-changed images generated in a case where image data of a job is image data obtained by reducing a special document ½ times;

FIGS. 5A to 5F are diagrams schematically illustrating a plurality of magnification-changed images generated in a case where image data of a job is image data magnified at an equal magnification of the special document;

FIGS. 6A to 6F are diagrams schematically illustrating a plurality of magnification-changed images generated in a case where image data of a job is image data obtained by enlarging the special document twice;

FIGS. 7A to 7F are diagrams schematically illustrating a plurality of magnification-changed images generated in a case where image data of a job is image data obtained by enlarging the special document four times;

FIG. 8 is a first part of a flowchart illustrating operation of the image forming apparatus in the first embodiment of the present invention of the present invention;

FIG. 9 is a second part of the flowchart illustrating the operation of the image forming apparatus in the first embodiment of the present invention;

FIG. 10 is a block diagram illustrating operation in which an image forming apparatus detects a specific image in a second embodiment of the present invention;

FIGS. 11, 11A, and 11B are a flowchart illustrating operation of the image forming apparatus in the second embodiment of the present invention;

FIGS. 12A to 12C are diagrams conceptually illustrating processing order of specific image detection processing performed for a magnification-changed image in the second embodiment of the present invention;

FIGS. 13A to 13C are diagrams conceptually illustrating processing order of the specific image detection processing performed for a magnification-changed image in a state in which a processing speed of a CPU is set to N times a reference speed in the second embodiment of the present invention;

FIG. 14 is a block diagram illustrating operation in which an image forming apparatus detects a specific image in a third embodiment of the present invention;

FIGS. 15A to 15E are diagrams to describe a method of determining a magnification of a magnification-changed image in which the specific image is detected in a case of detecting the specific image from a synthesized image obtained by adding an image magnified twice and an image magnified at an equal magnification in the third embodiment of the present invention;

FIGS. 16A to 16E are diagrams to describe a method of determining a magnification of a magnification-changed image in which the specific image is detected in a case of detecting the specific image from a synthesized image obtained by adding an image magnified twice and an image magnified ½ times in the third embodiment of the present invention;

FIGS. 17A to 17E are diagrams to describe a method of determining a magnification of a magnification-changed image in which the specific image is detected in a case of detecting the specific image from a synthesized image obtained by adding an image magnified twice and an image magnified ¼ times in the third embodiment of the present invention;

FIGS. 18, 18A and 18B are a flowchart illustrating operation of the image forming apparatus in the third embodiment of the present invention;

FIGS. 19A and 19B are diagrams conceptually illustrating processing order of specific image detection processing performed in the third embodiment of the present invention;

FIG. 20 is a block diagram illustrating a first example of specific image detection processing performed by an image forming apparatus in the related art; and

FIG. 21 is a block diagram illustrating a second example of specific image detection processing performed by an image forming apparatus in the related art.

### DETAILED DESCRIPTION OF EMBODIMENTS

Hereinafter, one or more embodiments of the present invention will be described with reference to the drawings. However, the scope of the invention is not limited to the disclosed embodiments.

In the following embodiments, a case where an image processing apparatus is a multifunction peripheral (MFP) will be described. The image processing apparatus may also be an image forming apparatus other than the MFP, for example, a printer, a copying machine, a scanner, or the like, or may be an apparatus other than the image forming apparatus, such as a personal computer (PC) or a portable terminal.

### First Embodiment

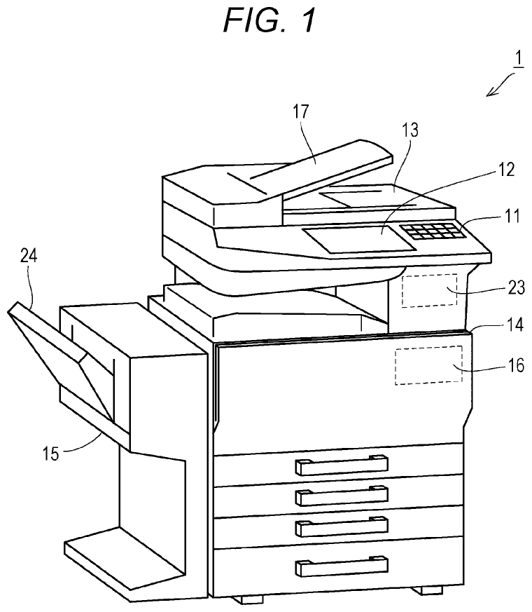

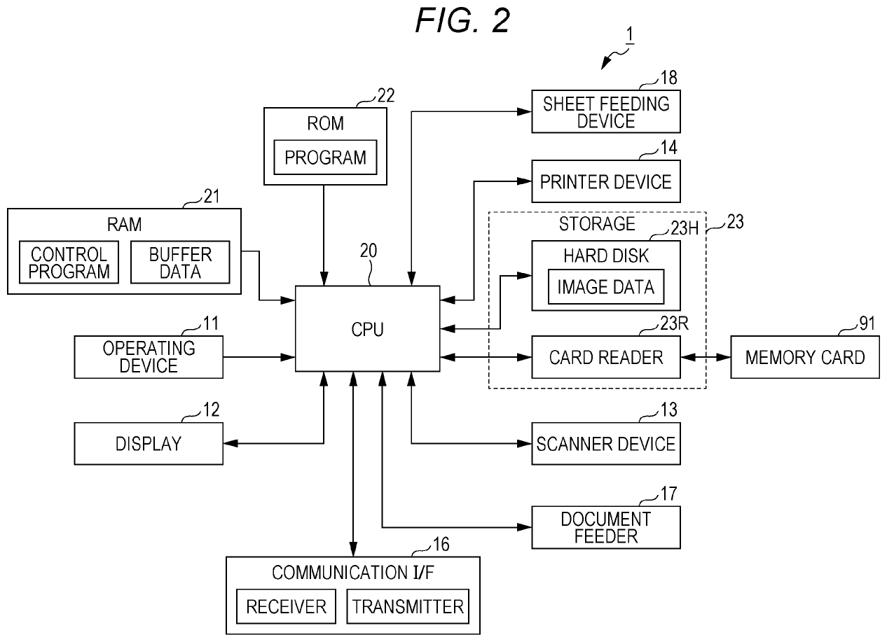

FIG. 1 is a perspective view illustrating an image forming apparatus 1 according to a first embodiment of the present invention. FIG. 2 is a block diagram illustrating components of the image forming apparatus 1 according to the first embodiment of the present invention.

Referring to FIGS. 1 and 2, the image forming apparatus 1 in the present embodiment is an MFP in which functions as a copy machine, a network printing machine, a scanner, a facsimile machine, a document server, and the like are integrated. In a case of using such an image forming apparatus 1, it is possible to provide a setting in which usage is not permitted unless authentication is performed based on user information registered in the image forming apparatus 1.

The image forming apparatus 1 includes an operating device 11 (an example of an additional edit receiver), a display 12, a scanner device 13, a printer device 14, a finisher device 15, a communication interface 16, a document feeder 17, a sheet feeding device 18, a CPU 20 (an example of a restrictor), a random access memory (RAM) 21 (an example of an image memory), a read only memory (ROM) 22, a storage 23, and the like.

The operating device 11 includes a plurality of keys to input numbers, letters, symbols and the like, a sensor that recognizes a pressed key, a transmission circuit that transmits, to the CPU 20, a signal indicating the recognized key.

The display 12 displays a screen to provide a message or a command to a user, a screen for the user to input a setting matter and a processing matter, a screen indicating an image formed by the image forming apparatus 1 and a processing result. Here, a touch panel is used as the display 12. Therefore, the display 12 detects a position on the touch panel touched by the user with the finger, and transmits a signal indicating the detection result to the CPU 20.

Thus, the operating device 11 and the display 12 play a role of a user interface for the user to directly operate the image forming apparatus 1. Note that the user can also remotely operate the image forming apparatus 1 via an external apparatus such as a PC (not illustrated) in which an application program and a driver to provide a command to the image forming apparatus 1 are installed.

The scanner device 13 photoelectrically acquires image data by photoelectrically reading image information such as a photograph, a character, or a picture from a document. The acquired image data (density data) is converted to digital data in an image processor (not illustrated), subjected to various kinds of known image processing, transmitted to the printer device 14 and the communication interface 16, and provided for image printing and data transmission. Alternatively, the acquired image data (density data) is converted to digital data in the image processor (not illustrated) and stored in the storage 23 for later use.

The printer device 14 prints, on a recording sheet such as a paper sheet or a film: image data acquired by the scanner device 13; image data received by the communication interface 16 from the external apparatus; or an image stored in the storage 23.

The finisher device 15 performs post-processing such as stapling or punching for the recording sheet (namely, printed matter) on which the image has been printed by the printer device 14, and ejects the recording sheet to a tray 24.

The communication interface 16 includes a transmitter, a receiver, and the like. The communication interface 16 includes a wireless communication device, a network interface card (NIC), a modem, a terminal adapter (TA), and the like to exchange data with a portable viewing terminal and electronic paper.

The document feeder 17 feeds a document to an image reading position of the scanner device 13.

The sheet feeding device 18 is provided at a lower part of a body of the image forming apparatus 1 and used to supply the printer device 14 with a recording sheet suitable for an image to be printed.

The CPU 20 controls the entire image forming apparatus 1 in accordance with a control program. The CPU 20 loads, onto the RAM 21, the control program stored in the ROM 22 and executes the loaded control program.

The RAM 21 is a main memory of the CPU 20. The RAM 21 temporarily stores the control program, buffer data described later, and the like. The RAM 21 includes: a processing block buffer that is a storage area to temporarily store buffer data and the like; and a print image memory that is a storage area to temporarily store image data and the like.

The ROM 22 stores various programs executed by the CPU 20, various fixed data, and the like.

The storage 23 includes a hard disk 23H, a card reader 23R, and the like. The card reader 23R reads data from a memory card 91 such as a Compact Flash (registered trademark) or a smart medium. Additionally, the card reader 23R writes data in the memory card 91. The memory card 91 is mainly used to: exchange data with the external apparatus not via a communication line; make a backup of data; and the like.

The hard disk 23H stores image data read by the scanner device 13, image data received from the external device by the communication interface 16, and the like. Reference can be made to the data stored in the hard disk 23H from other image forming apparatuses via a network.

Next, operation in which the image forming apparatus 1 detects a specific image will be described.

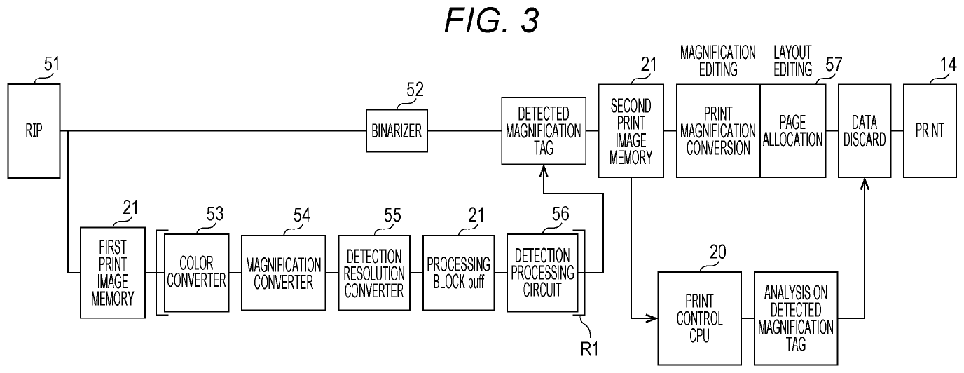

FIG. 3 is a block diagram illustrating operation in which the image forming apparatus 1 detects a specific image in the first embodiment of the present invention.

Referring to FIG. 3, the image forming apparatus 1 includes an RIP 51, a binarizer 52, a color converter 53, a magnification converter 54 (an example of a magnification changer), a detection resolution converter 55 (an example including a resolution changer and a buffering device), a detection processing circuit 56 (an example including a detector and a magnification storage device), and an editor 57. The RIP 51, the binarizer 52, the color converter 53, the magnification converter 54, the detection resolution converter 55, the detection processing circuit 56, and the editor 57 are implemented by the CPU 20 executing the control program stored in the ROM 22.

When image data is received via the communication interface 16 or the scanner device 13 (an example of receiver) in a job such as a print job or a copy job, the RIP 51 generates raster data of the image data to be printed in accordance with the job by performing RIP processing for the image data included in the job. The RIP 51 stores the generated raster data (image data before binarization) in a first print image memory area inside the RAM 21.

Note that an external device that is a transmission source of a print job may also perform the RIP processing for the image data, instead of the image forming apparatus 1 performing the RIP processing. In this case, the image forming apparatus 1 receives the print job including raster data of the image data from the external device.

On the other hand, the binarizer 52 binarizes the generated raster data. The binarized data is stored in a second print image memory area inside the RAM 21 together with a magnification of a magnification-changed image in which a specific image is detected in detection processing described later.

The color converter 53, the magnification converter 54, the detection resolution converter 55, and the detection processing circuit 56 generate each of a plurality of magnification-changed images based on the raster data of the image data (image data before binarization), and detect the specific image from each of the plurality of generated magnification-changed images.

Specifically, the color converter 53 performs, for the raster data of the image data, color conversion processing to separate only a color of the specific image from the raster data. The magnification converter 54 generates each of the plurality of magnification-changed images by changing a magnification of the image data subjected to the color conversion to each of a plurality of magnifications different from each other. The detection resolution converter 55 converts the data subjected to the magnification conversion to data having a resolution suitable for detecting the specific image. The data subjected to the resolution conversion is temporarily stored in an area of the processing block buffer inside the RAM 21. The processing block buffer inside the RAM 21 has a capacity of a size capable of storing a magnification-changed image having a predetermined block size or a predetermined band size. The detection processing circuit 56 detects the specific image from the plurality of magnification-changed images. The detection processing circuit 56 performs detection processing to detect the specific image from the data stored in the processing block buffer.

A series of processing from generation of a magnification-changed image by changing a magnification of image data at one magnification until execution of the detection processing for the generated magnification-changed image will be defined as processing R1. In parallel to the binarization processing by the binarizer 52, the color converter 53, the magnification converter 54, the detection resolution converter 55, and the detection processing circuit 56 sequentially generate each of the plurality of magnification-changed images by repeating the processing R1 for the raster data of the image data while changing a magnification for magnification change, and perform the specific image detection processing for each of the generated magnification-changed images.

It is preferable that the magnification at the time of generating each of the plurality of magnification-changed image be a magnification that can be set as a printing condition of the image forming apparatus 1, and examples of such a magnification here include twice, an equal magnification, ½ times, and ¼ times. Additionally, it is preferable to perform the specific image detection processing for each generated magnification-changed image every time each magnification-changed image of the predetermined block size or the predetermined band size is generated. Consequently, a size of the processing block buffer inside the RAM 21 can be reduced.

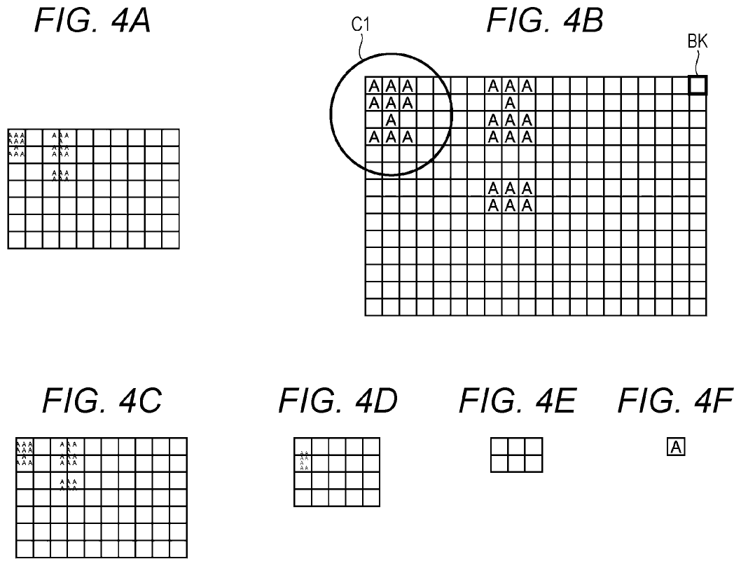

FIGS. 4A to 4F are diagrams schematically illustrating a plurality of magnification-changed images generated in a case where image data of a job is image data obtained by reducing a special document ½ times; FIG. 4A illustrates the mentioned image data, and FIGS. 4B to 4E illustrate the magnification-changed images generated by changing a magnification of the image data of FIG. 4A to magnifications of twice, the equal magnification (no magnification change), ½ times, and ¼ times respectively, and FIG. 4F illustrates a reference mark used for comparison with each of the magnification-changed images. The reference mark is stored in the hard disk 23H.

Note that the reference mark is indicated by an alphabet “A” in the drawings. Here, the reference mark is an image same as the specific image, but may also be an image obtained by changing a magnification of the specific image at a predetermined magnification.

Referring to FIGS. 4A to 4F, the detection processing circuit 56 divides each of the magnification-changed images into a plurality of blocks BK having a predetermined size, and compares each of the plurality of blocks BK with the reference mark, thereby detecting the specific image from each of the magnification-changed images.

Since the image data illustrated in FIG. 4A is obtained by magnifying the special document ½ times, the specific image included in the image data is also magnified ½ times. Therefore, the specific image is not detected from the image magnified at the equal magnification (FIG. 4C). Also, the specific image is not detected from the image magnified ½ times (FIG. 4D) and the image magnified ¼ times (FIG. 4E). On the other hand, the specific image included in the image data is enlarged to a size of the original specific image in the image magnified twice (FIG. 4B). Therefore, the specific image is detected from an area C1 and the like of the image magnified twice.

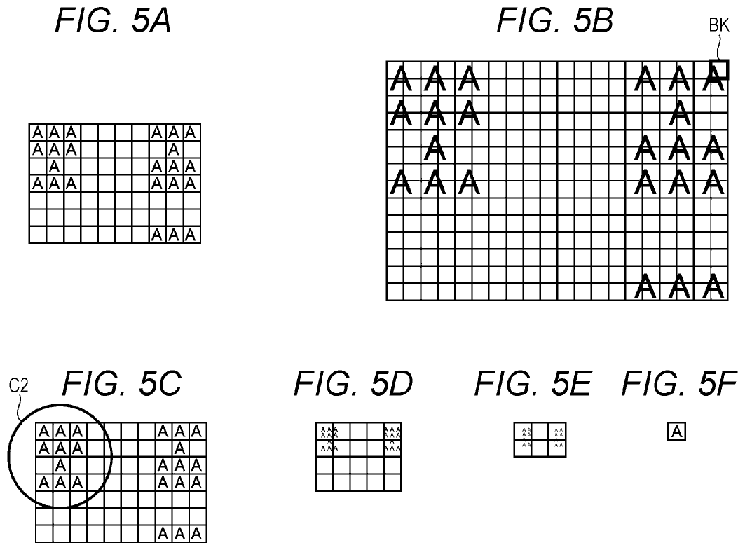

FIGS. 5A to 5F are diagrams schematically illustrating a plurality of magnification-changed images generated in a case where image data of a job is image data having the equal magnification of the special document.

FIG. 5A illustrates the mentioned image data, and FIGS. 5B to 5E illustrate the magnification-changed images generated by changing a magnification of the image data of FIG. 5A to magnifications of twice, the equal magnification, ½ times, and ¼ times respectively, and FIG. 5F illustrates a reference mark used for comparison with each of the magnification-changed images.

Referring to FIGS. 5A to 5F, since the image data illustrated in FIG. 5A is the special document having the equal magnification, the specific image is not detected from the image magnified twice (FIG. 5B), the image magnified ½ times (FIG. 5D), and the image magnified ¼ times (FIG. 5E). On the other hand, in the image magnified at the equal magnification (FIG. 5C), the specific image is detected from a region C2 and the like.

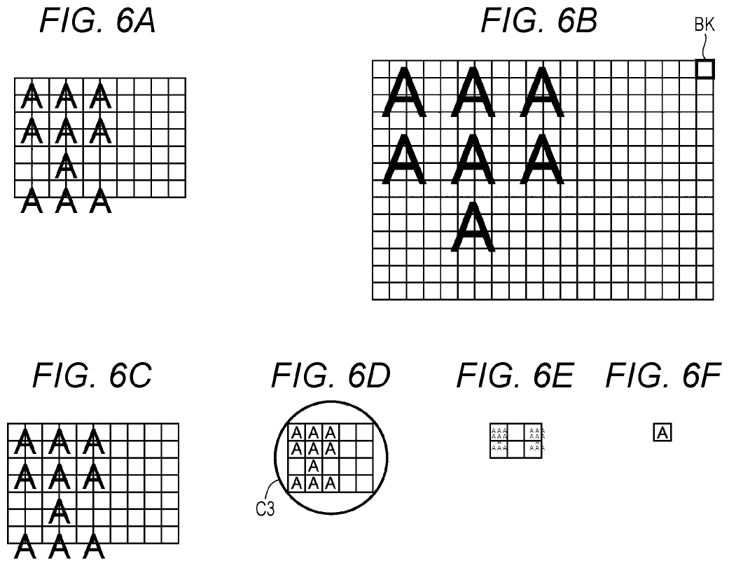

FIGS. 6A to 6F are diagrams schematically illustrating a plurality of magnification-changed images generated in a case where image data of a job is image data obtained by enlarging the special document twice. FIG. 6A illustrates the mentioned image data, and FIGS. 6B to 6E illustrate the magnification-changed images generated by changing a magnification of the image data of FIG. 6A to magnifications of twice, the equal magnification, ½ times, and ¼ times respectively, and FIG. 6F illustrates a reference mark used for comparison with each of the magnification-changed images.

Referring to FIGS. 6A to 6F, since the image data illustrated in FIG. 6A is obtained by magnifying the special document twice, the specific image included in the image data is also magnified twice. Therefore, the specific image is not detected from the image magnified at the equal magnification (FIG. 6C). Also, the specific image is not detected from the image magnified twice (FIG. 6B) and the image magnified ¼ times (FIG. 6E). On the other hand, the specific image included in the image data is reduced to a size of the original specific image in the image magnified ½ times (FIG. 6D). Therefore, the specific image is detected from an area C3 or the like of the image magnified ½ times.

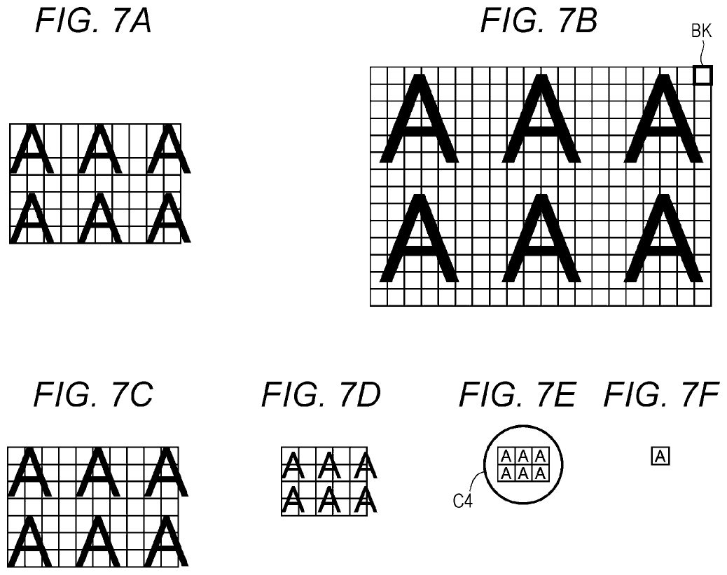

FIGS. 7A to 7F are diagrams schematically illustrating a plurality of magnification-changed images generated in a case where image data of a job is image data obtained by enlarging the special document four times. FIG. 7A illustrates the mentioned image data, and FIGS. 7B to 7E illustrate the magnification-changed images generated by changing a magnification of the image data of FIG. 7A to respective magnifications of twice, the equal magnification, ½ times, and ¼ times, and FIG. 7F illustrates a reference mark used for comparison with each of the magnification-changed images.

Referring to FIGS. 7A to 7F, since the image data illustrated in FIG. 7A is obtained by magnifying the special document four times, the specific image included in the image data is also magnified four times. Therefore, the specific image is not detected from the image magnified at the equal magnification (FIG. 7C). Also, the specific image is not detected from the image magnified twice (FIG. 7B) and the image magnified ½ times (FIG. 7D). On the other hand, the specific image included in the image data is reduced to a size of the original specific image in the image magnified ¼ times (FIG. 7E). Therefore, the specific image is detected from an area C4 of the image magnified ¼ times.

Note that in a case where the detection processing circuit 56 detects the specific image from a specific magnification-changed image among the plurality of magnification-changed images during the detection processing, the specific image detection processing may be partly continued for the magnification-changed image from which the specific image has been detected (or the magnification-changed image from which the specific image has been detected and a magnification-changed image having a magnification close a magnification of such a magnification-changed image) among the plurality of magnification-changed images, and the specific image detection processing from other magnification-changed images may be cancelled. Consequently, the detection processing can be continued focusing on the magnification-changed image including the specific image, and a burden of the detection processing can be reduced.

Referring to FIG. 3, when the specific image detection processing for all of the magnification-changed images is completed, the detection processing circuit 56 deletes the image data before binarization stored in the first print image memory.

In a case where the specific image is detected from one of the plurality of magnification-changed images, the detection processing circuit 56 associates (tags), with the binarized data, the magnification of the magnification-changed image from which the specific image is detected, and stores the magnification in the second print image memory area inside the RAM 21. Specifically, in a case where the specific image is detected from the image magnified twice like FIGS. 4A to 4F, the magnification of “twice” is associated and stored, and in a case where the specific image is detected from the image magnified at the equal magnification like FIGS. 5A to 5F, the “the equal magnification” is associated and stored. In a case where the specific image is detected from the image magnified ½ times like FIGS. 6A to 6F, the magnification of “½ times” is associated and stored, and in a case where the specific image is detected from the image magnified ¼ times like FIGS. 7A to 7F, the magnification of “¼ times” is associated and stored. Hereinafter, the tagged magnification of the magnification-changed image may be referred to as a detection tag.

On the other hand, in a case where the specific image is not detected from any one of the magnification-changed images, the detection processing circuit 56 does not tag a magnification of a magnification-changed image.

After finishing the specific image detection processing, the operating device 11 receives, from a user, additional edit operation (edit operation to change the magnification of the image data) relative to the job. The editor 57 converts the binarized data to print data (data to be finally output) in accordance with the received additional edit operation.

Note that the operating device 11 may be set so as not to receive additional edit operation like changing the magnification of the image data to a magnification different from the magnification at the time of generating each of the plurality of magnification-changed images.

In a case where the specific image is detected from the plurality of magnification-changed images, the CPU 20 restricts printing of the image data under at least a part of the printing conditions. Specifically, the CPU 20 restricts printing of the image data at a magnification within a predetermined range determined based on the magnification of the detection tag.

For example, in a case of defining a magnification for magnification change set in a job as a magnification M1, defining a magnification for magnification change set in additional edit operation as a magnification M2, and defining a magnification of a detection tag as a magnification M3, when a product of the magnification M1 and the magnification M2 is a magnification within a predetermined range determined based on the magnification M3 (for example, in a case of satisfying a relation in Expression (1)), the CPU 20 restricts printing under a printing condition in accordance with the additional edit operation.

M3×0.9≤M1×M2≤M3×1.1 (1)

In the case of restricting printing, the CPU 20 stops printing performed by the printer device 14 and restricts the printing by deleting (discarding) the binarized image data from the second print image memory. Additionally, the CPU 20 may correct print data to have a magnification different from the setting by the additional edit operation or the like, and may print the corrected print data.

On the other hand, when the magnifications M1, M2, and M3 do not satisfy the relation in Expression (1), the CPU 20 does not restrict the printing in accordance with the additional edit operation. At this time, the printer device 14 performs printing of an image obtained by magnifying the image data at a magnification corresponding to the product of the magnification M1 and the magnification M2 based on the binarized image data.

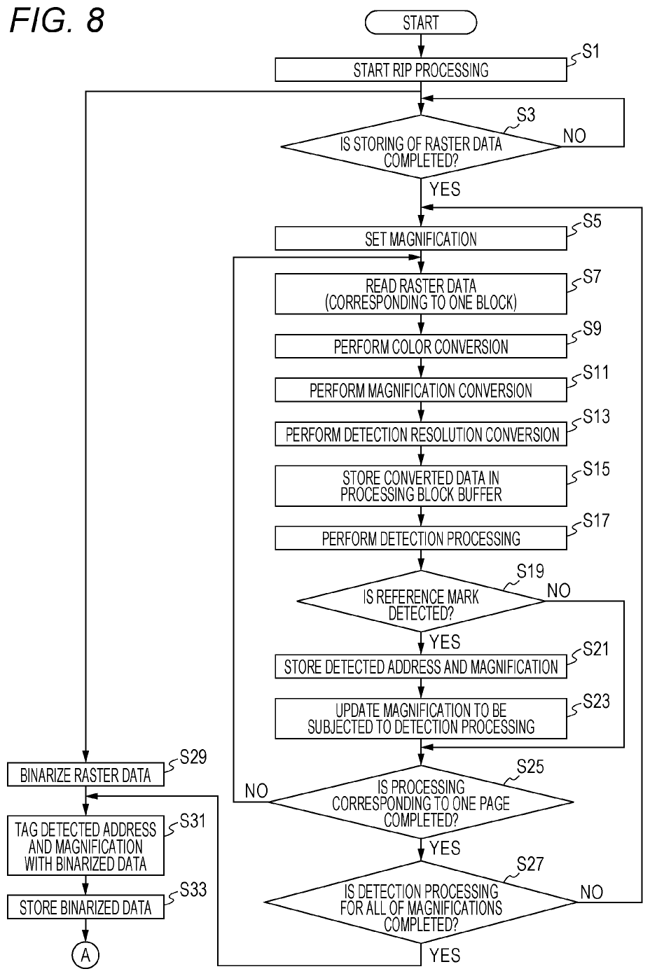

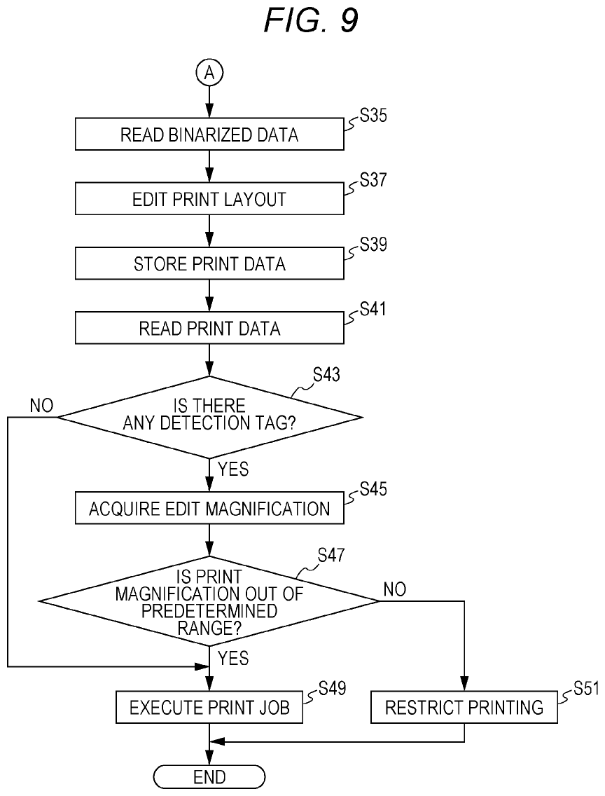

FIGS. 8 and 9 are flowcharts illustrating operation of the image forming apparatus 1 in the first embodiment of the present invention.

Referring to FIG. 8, when a job execution command is received, the CPU 20 starts the RIP processing for image data included in the job (S1) and determines whether storing of raster data of the image data in the second print image memory is completed (S3). The CPU 20 repeats the processing in step S3 until it is determined that the storing of the raster data of the image data is completed.

In step S3, in a case of determining that the storing of the raster data of the image data is completed (YES in S3), the CPU 20 sets a magnification for magnification change (S5), and reads the raster data of the image data corresponding to one block from the second print image memory (S7). Next, the CPU 20 performs, for the read data, respective processing including color conversion (S9), magnification conversion (S11), and detection resolution conversion (S11) to generate a magnification-changed image corresponding to one block, and temporarily stores the obtained magnification-changed image in the processing block buffer (S15). Subsequently, the CPU 20 performs detection processing for the magnification-changed image stored in the processing block buffer (S17), and determines whether a reference mark is detected from the magnification-changed image (S19).

In step S19, in a case of determining that the reference mark is detected from the magnification-changed image (YES in S19), the CPU 20 stores, in the RAM 21, a detected address (a place where the reference mark is detect in the magnification-changed image) and a magnification of the magnification-changed image (S21), updates a magnification of a magnification-changed image to be subjected to the detection processing (magnification not yet subjected to the detection processing) only to the magnification of the current magnification-changed image (S23), and proceeds to processing in step S25.

In step S19, in a case of determining that the reference mark is not detected from the magnification-changed image (NO in S19), the CPU 20 proceeds to the processing in step S25.

In step S25, the CPU 20 determines whether the specific image detection processing for the magnification-changed image corresponding to one page is completed (S25). In step S25, in a case of determining that the specific image detection processing for the magnification-changed image corresponding to the one page is not completed (NO in S25), the CPU 20 proceeds to processing in step S7.

In step S25, in a case of determining that the specific image detection processing for the magnification-changed image corresponding to the one page is completed (YES in S25), the CPU 20 determines whether the specific image detection processing for the magnification-changed images of all of the magnifications is completed (S27). In step S27, in a case of determining that the specific image detection processing for the magnification-changed images of all of the magnifications is not completed (NO in S27), the CPU 20 proceeds to the processing in step S5.

In step S27, in a case of determining that the specific image detection processing for the magnification-changed images of all of the magnifications is completed (YES in S27), the CPU 20 proceeds to processing in step S31.

On the other hand, when the RIP processing for the image data included in the job is started (S1), the CPU 20 binarizes the raster data of the image data (S29) in parallel with the processing from step S3, and proceeds to the processing of the step S31.

In step S31, in a case where there are a detected address and a detected magnification of a magnification-changed image stored in the RAM 21, the CPU 20 associates the address and the magnification with the binarized data as a detection tag (S31), and stores the magnification together with the binarized data in the second print image memory (S33). Next, the CPU 20 proceeds to processing in step S35 in FIG. 9.

Referring to FIG. 9, the CPU 20 reads the binarized data in step S35 and edits a print layout of the binarized data in accordance with received additional edit operation (S37), and then stores the edited data as print data in the second print image memory (S39). In step S39, in a case where there is a detection tag for the binarized data, the print data is stored together with the detection tag.

Next, the CPU 20 reads the print data (S41) and determines whether there is any detection tag for the print data (S43). In step S43, in a case of determining that there is no detection tag (NO in S43), the CPU 20 proceeds to the processing in step S49.

In step S43, in a case of determining that there is a detection tag (YES in S43), the CPU 20 acquires the magnification set in the additional edit operation (S45), and determines whether a print magnification (the product of the magnification set in the job and the magnification for magnification change set in the additional edit operation) is out of a predetermined range (S47).

In step S47, in a case of determining that the print magnification is out of the predetermined range (YES in S47), the CPU 20 executes printing in accordance with the setting (S49) and finishes the processing.

In step S47, in a case of determining that the print magnification is not out of the predetermined range (NO in S47), the CPU 20 restricts printing (S51) and finishes the processing. In a case of restricting the printing, the CPU 20 may modify the print data to have a magnification different from the setting and print the modified print data or may stop the printing.

In the present embodiment, the magnification-changed images are generated at the plurality of magnifications at which images can be possibly output as printed matters, and the specific image detection processing is performed for each of the generated magnification-changed images Therefore, even in a case where a magnification of image data is changed by additional edit operation relative to a job, the specific image detection processing can be performed for the image data subjected to the magnification change, and specific image detection accuracy can be improved. Additionally, the image data before binarization, which is stored in the first print image memory, is deleted before the binarized data is stored in the second print image memory. Therefore, consumption of the memory that stores the image data can be reduced.

### Second Embodiment

In the present embodiment, an example of generating a plurality of magnification-changed images in parallel will be described.

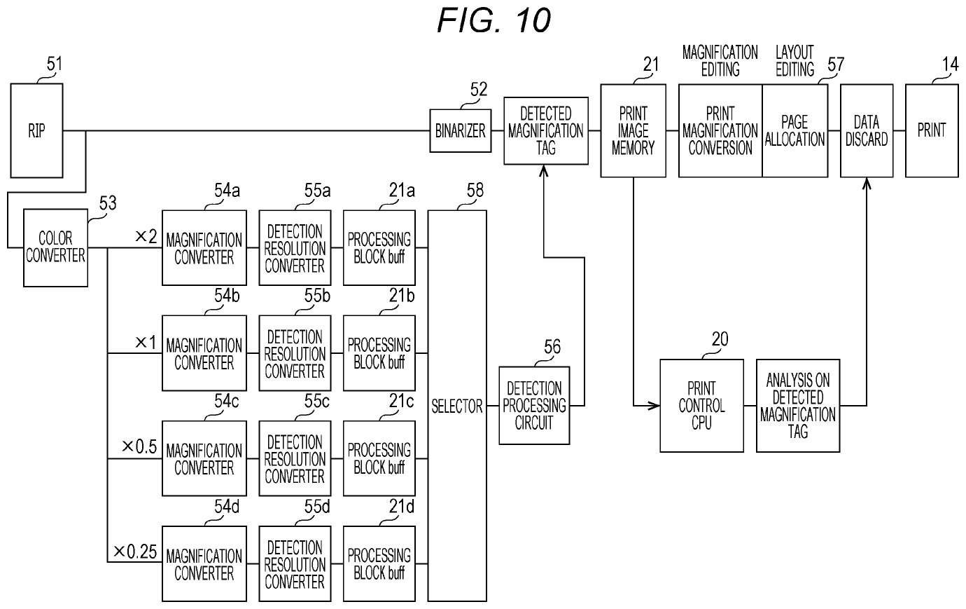

FIG. 10 is a block diagram illustrating operation in which an image forming apparatus 1 detects a specific image in a second embodiment of the present invention.

Referring to 10, the image forming apparatus 1 includes an RIP 51, a binarizer 52, a color converter 53, magnification converters 54a, 54b, 54c, and 54d, detection resolution converters 55a, 55b, 55c, and 55d (examples each including a resolution changer and a buffering device), a detection processing circuit 56, an editor 57, and a selector 58 (an example of a switcher). The RIP 51, the binarizer 52, the color converter 53, the magnification converters 54a, 54b, 54c, and 54d, the detection resolution converters 55a, 55b, 55c and 55d, the editor 57, and the selector 58 are implemented by a CPU 20 executing a control program stored in a ROM 22. ARAM 21 includes an area of a plurality of processing block buffers 21a, 21b, 21c, and 21d (examples of a buffer) to store a plurality of magnification-changed images respectively.

The magnification converter 54a, the detection resolution converter 55a, and the processing block buffer 21a are components to perform specific image detection processing for an image magnified twice. The magnification converter 54b, the detection resolution converter 55b, and the processing block buffer 21b are components to perform the specific image detection processing for an image magnified at an equal magnification. The magnification converter 54c, the detection resolution converter 55c, and the processing block buffer 21c are components to perform the specific image detection processing for an image magnified ½ times. The magnification converter 54d, the detection resolution converter 55d, and the processing block buffer 21d are components to perform the specific image detection processing for an image magnified ¼ times.

When a job is received, the RIP 51 generates raster data of image data to be printed in accordance with the job by performing RIP processing for the image data included in the job. The color converter 53 performs, for the raster data of the image data, color conversion processing to separate only a color of the specific image from the raster data. The color converter 53 feeds the data subjected to the color conversion processing to each of the magnification converters 54a, 54b, 54c, and 54d.

The magnification converter 54a converts the received data to have a necessary magnification. The detection resolution converter 55a converts the data subjected to the magnification conversion to data having a predetermined resolution suitable for detecting the specific image. The detection resolution converter 55a temporarily stores the data subjected to the resolution conversion in the processing block buffer 21a as a magnification-changed image having a predetermined magnification (twice here). Each of the processing block buffers 21a, 21b, 21c, and 21d has a capacity of a size capable of storing a magnification-changed image having a predetermined block size or a predetermined band size.

Similarly, the magnification converter 54b and the detection resolution converter 55b generate a magnification-changed image of a predetermined magnification (equal magnification here) by converting the received data to data having the necessary magnification and the necessary resolution, and temporarily stores the magnification-changed image in the processing block buffer 21b. The magnification converter 54c and the detection resolution converter 55c generate a magnification-changed image of a predetermined magnification (½ times here) by converting the received data to data having the necessary magnification and the necessary resolution, and temporarily stores the magnification-changed image in the processing block buffer 21c. The magnification converter 54d and the detection resolution converter 55d generate a magnification-changed image of a predetermined magnification (¼ times here) by converting the received data to data having the necessary magnification and the necessary resolution, and temporarily stores the magnification-changed image in the processing block buffer 21d.

The selector 58 selectively switches, among the processing block buffers 21a, 21b, 21c, and 21d, a processing block buffer to be a detection target. In a case where a size of the stored data reaches the predetermined size (predetermined block size or predetermined band size) in any one of the plurality of processing block buffers 21a, 21b, 21c, and 21d, the selector 58 sets such a processing block buffer as a detection target, and feeds the block or the band of the magnification-changed image stored in the processing block buffer to the detection processing circuit 56.

In a case where the size of the stored data reaches the predetermined size in two or more processing block buffers out of the plurality of processing block buffers 21a, 21b, 21c, and 21d, the selector 58 preferentially sets, as a detection target, a processing block buffer in which a magnification-changed image having a higher magnification for magnification change is stored. The reason is that the magnification-changed image having the higher magnification for magnification change has a larger entire size of the magnification-changed image, and requires longer time to perform the specific image detection processing.

The detection processing circuit 56 performs the specific image detection processing for the magnification-changed image stored in the processing block buffer set as the detection target by the selector 58.

When the specific image detection processing for the magnification-changed image of the processing block buffer set as the detection target is completed, all of the data stored in the processing block buffer set as the detection target is deleted, and a new magnification-changed image is stored in the processing block buffer. The selector 58 sets, as a detection target, another processing block buffer in which the size of the stored data reaches the predetermined size.

When the specific image detection processing for all of the magnification-changed images is completed, in a case where the specific image is detected from any one of the plurality of magnification-changed images, the detection processing circuit 56 associates, with binarized data, the magnification of the magnification-changed image in which the specific image is detected, and stores the magnification in a print image memory area inside the RAM 21.

On the other hand, in a case where the specific image is not detected from any one of the magnification-changed images, the detection processing circuit 56 does not tag a magnification of a magnification-changed image.

After that, the image forming apparatus 1 determines whether to restrict printing by performing processing similar to processing in a case of a first embodiment, and restricts printing as necessary.

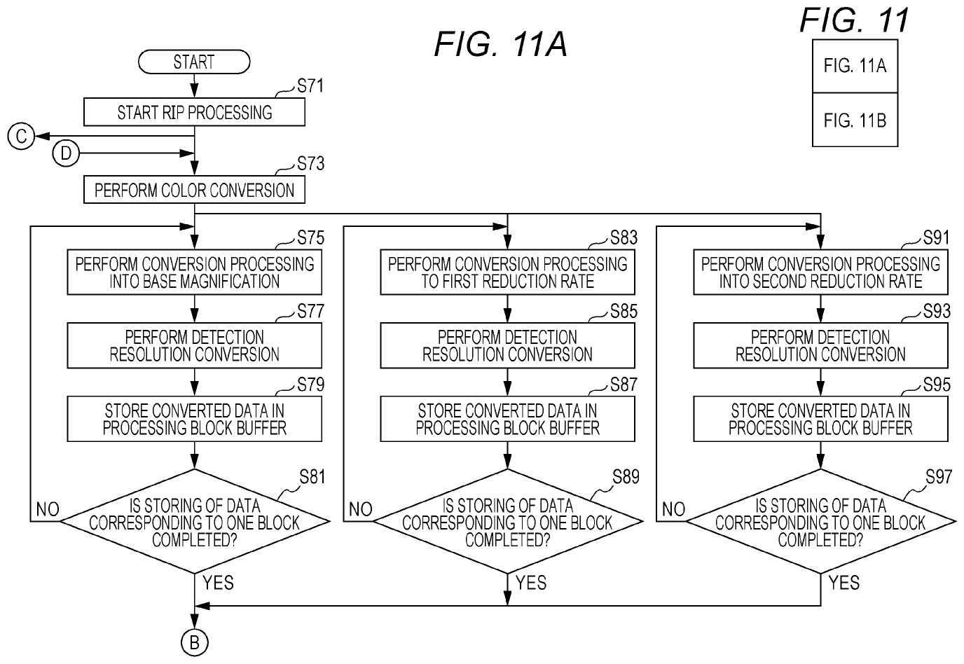

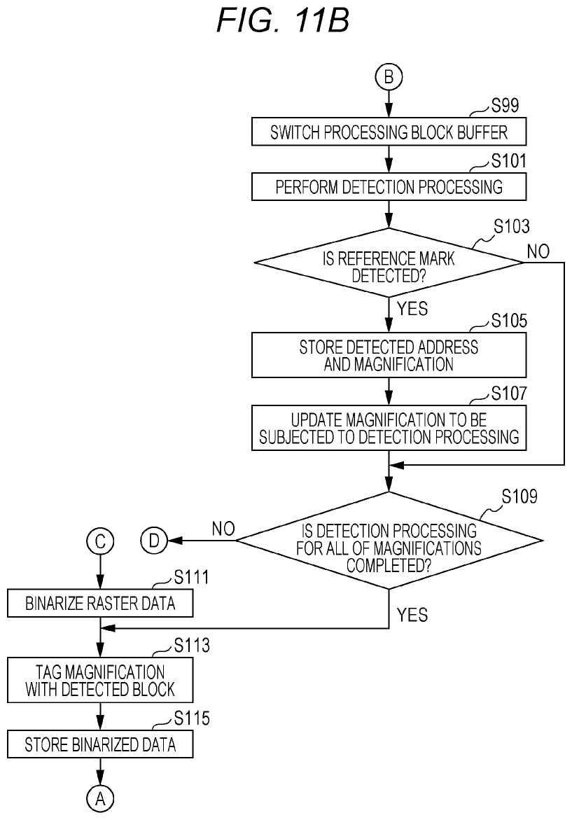

FIG. 11 is a flowchart illustrating operation of the image forming apparatus 1 according to the second embodiment of the present invention.

Referring to FIG. 11, when a job execution command is received, the CPU 20 starts the RIP processing for image data included in the job (S71), performs color conversion processing for raster data of the image data obtained by the RIP processing (S73). Subsequently, the CPU 20 performs, for the data subjected to the color conversion processing, conversion processing to an equal magnification (base magnification) (S75) and conversion processing to a detection resolution (S77), and stores the obtained data in a processing block buffer (S79). Then, the CPU 20 determines whether data corresponding to one block is stored in the processing block buffer (S81).

In step S81, in a case of determining that the data corresponding to the one block is not stored in the processing block buffer (NO in S81), the CPU 20 proceeds to the processing in step S75. On the other hand, in step S81, in a case of determining that data corresponding to the one block is stored in the processing block buffer (YES in S81), the CPU 20 proceeds to processing in step S99.

The CPU 20 performs following processing in parallel with the processing in steps S75 to S81. The CPU 20 performs, for the data subjected to the color conversion processing, conversion processing to a first reduction rate (S83) and conversion processing to a detection resolution (S85) and stores the obtained data in the processing block buffer (S87). Subsequently, the CPU 20 determines whether data corresponding to one block is stored in a processing block buffer (S89).

In step S89, in a case of determining that the data corresponding to the one block is not stored in the processing block buffer (NO in S89), the CPU 20 proceeds to the processing in step S83. On the other hand, in step S89, in a case of determining that data corresponding to the one block is stored in the processing block buffer (YES in S89), the CPU 20 proceeds to processing in step S99.

The CPU 20 further performs following processing in parallel with the processing in steps S75 to S81. The CPU 20 performs, for the data subjected to the color conversion processing, conversion processing into a second reduction rate (S91) and conversion processing to a detection resolution (S93) and stores the obtained data in the processing block buffer (S95). Subsequently, the CPU 20 determines whether data corresponding to one block is stored in a processing block buffer (S97).

In step S97, in a case of determining that the data corresponding to the one block is not stored in the processing block buffer (NO in S97), the CPU 20 proceeds to the processing in step S91. On the other hand, in step S97, in a case of determining that data corresponding to the one block is stored in the processing block buffer (YES in S97), the CPU 20 proceeds to processing in step S99.

In step S99, the CPU 20 selectively switches, to the processing block buffer in which the data corresponding to the one block is stored, the processing block buffer to be the detection target (S99), and performs the specific image detection processing for the magnification-changed image stored in the processing block buffer selected as the detection target (S101). Next, the CPU 20 determines whether a reference mark is detected from the magnification-changed image (S103).

In step S103, in a case of determining that the reference mark is detected from the magnification-changed image (YES in S103), the CPU 20 stores, in the RAM 21, a detected address (a place where the reference mark is detected in the magnification-changed image) and a magnification of the magnification-changed image (S105), updates a magnification of a magnification-changed image to be subjected to the detection processing (magnification not yet subjected to the detection processing) only to the magnification of the current magnification-changed image (S107), and proceeds to processing in step S109. On the other hand, in step S103, in a case of determining that the reference mark is not detected from the magnification-changed image (NO in S103), the CPU 20 proceeds to the processing in step S109.

In step S109, the CPU 20 determines whether the specific image detection processing for the magnification-changed images of all of the magnifications is completed (S109).

In step S109, in a case of determining that the specific image detection processing for the magnification-changed images of all of the magnifications is not completed (NO in S109), the CPU 20 proceeds to the processing in step S73. On the other hand, in step S109, in a case of determining that the specific image detection processing for the magnification-changed image of all of the magnifications is completed (YES in S109), the CPU 20 proceeds to processing in step S113.

When the RIP processing for the image data included in the job is started (S71), the CPU 20 binarizes the raster data of the image data (S111) in parallel with the processing from step S73, and proceeds to the processing of the step S113.

In step S113, in a case where there are a detected address and a detected magnification of a magnification-changed image stored in the RAM 21, the CPU 20 associates the magnification with a detected block of the binarized data as a detection tag (S113), and stores the magnification in a print image memory inside the RAM 21 together with the binarized data (S115). After that, the CPU 20 performs processing from step S35 in FIG. 9.

Note that components and operation of the image forming apparatus 1 other than those described above are similar to those in the first embodiment, and therefore, a description thereof will not be repeated.

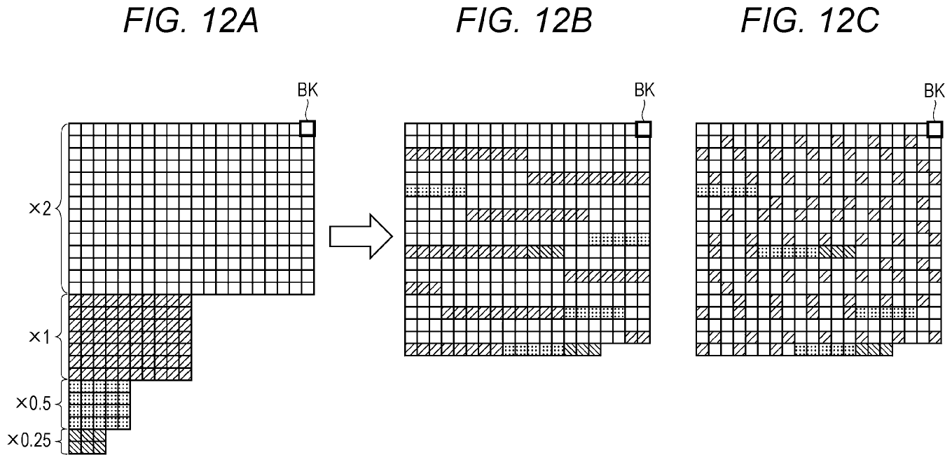

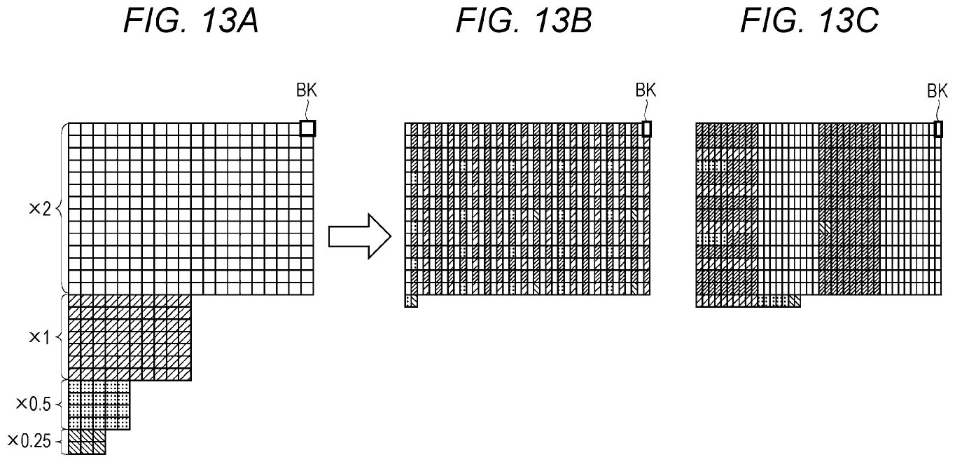

FIGS. 12A to 12C are diagrams conceptually illustrating processing order of the specific image detection processing performed for a magnification-changed image in the second embodiment of the present invention; FIG. 12A is the diagram conceptually illustrating the processing order of the specific image detection processing for the magnification-changed image in the first embodiment. FIG. 12B is the diagram conceptually illustrating the processing order of the specific image detection processing performed for the magnification-changed image in a case of performing the specific image detection processing per band in the second embodiment. FIG. 12C is the diagram conceptually illustrating processing order of the specific image detection processing performed for a magnification-changed image in a case of performing the specific image detection processing per block in the second embodiment. In FIGS. 12A to 12C and FIGS. 13A to 13C, it is assumed that the processing proceeds from an upper row to a lower row. One rectangle corresponds to one block BK which is a minimum unit in which the specific image detection processing is performed. Also, in FIGS. 12A to 12C and FIGS. 13A to 13C, magnification-changed images magnified twice, at the equal magnification, ½ times, and ¼ times respectively are indicated by kinds of hatching different from each other.

Referring to FIG. 12A, in a case of sequentially generating each of the plurality of magnification-changed images and performing the specific image detection processing for the generated magnification-changed images like the first embodiment, the magnification-changed images are generated one by one, and the specific image detection processing is performed for only one generated magnification-changed image.

Referring to FIGS. 12B and 12C, on the other hand, according to the present embodiment, the processing to generate each of the plurality of magnification-changed images is performed in parallel, and each of the magnification-changed images is stored in a predetermined size (per band or per block) in a corresponding processing buffer block. Then, in a case where data of each magnification-changed image having the predetermined size is stored in each corresponding processing block buffer, the specific image detection processing is performed for the magnification-changed image stored in the processing block buffer. Consequently, a time required for the specific image detection processing can be shortened more than the case of the first embodiment. Furthermore, since it is not necessary to store magnification-changed images of all of the magnifications in a processing block buffer, the capacity of the processing block buffer can be reduced.

FIGS. 13A to 13C are diagrams conceptually illustrating processing order of specific image detection processing performed for a magnification-changed image in a state in which a processing speed of the CPU 20 is set to N times a reference speed in the second embodiment of the present invention. FIG. 13A is the diagram conceptually illustrating the processing order of the specific image detection processing for the magnification-changed image in the first embodiment. FIG. 13B is the diagram conceptually illustrating the processing order of the specific image detection processing performed for the magnification-changed image in the case of performing the specific image detection processing per band in the state in which the processing speed of the CPU 20 is set to N times the reference speed in the second embodiment. FIG. 13C is the diagram conceptually illustrating the processing order of the specific image detection processing performed for the magnification-changed image in the case of performing the specific image detection processing per block in the state in which the processing speed of the CPU 20 is set to N times the reference speed in the second embodiment.

Referring to FIGS. 13A to 13C, in the case of performing the specific image detection processing by using the CPU 20, it is preferable to set the processing speed (detection speed) of the CPU 20 to N times the reference speed that is a normal processing speed of the CPU 20. N represents a value calculated by “N=reference speed×total value of magnifications of the respective plurality of magnification-changed images”. Consequently, the speed of the detection processing can be improved without excessively increasing the speed.

### Third Embodiment

In the present embodiment, an example of synthesizing a plurality of magnification-changed images and performing specific image detection processing for the synthesized image will be described.

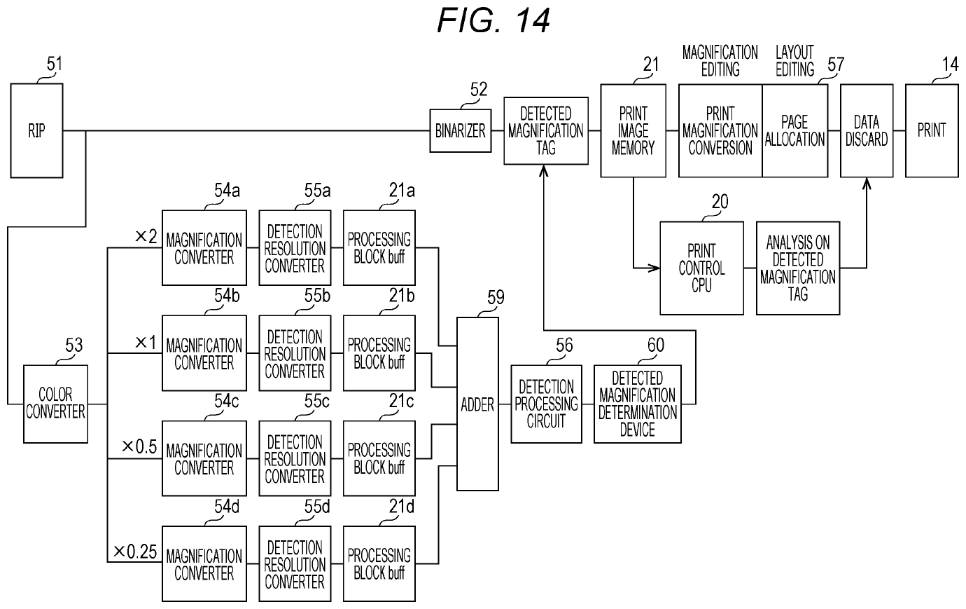

FIG. 14 is a block diagram illustrating operation in which an image forming apparatus 1 detects a specific image in a third embodiment of the present invention.

Referring to FIG. 14, the image forming apparatus 1 includes an RIP 51, a binarizer 52, a color converter 53, magnification converters 54a, 54b, 54c, and 54d, detection resolution converters 55a, 55b, 55c, and 55d, a detection processing circuit 56, an editor 57, an adder 59 (an example of an adding device), and a detected magnification determination device 60 (an example of a determination device). The RIP 51, the binarizer 52, the color converter 53, the magnification converters 54a, 54b, 54c, and 54d, the detection resolution converters 55a, 55b, 55c, and 55d, the editor 57, the adder 59 (the example of the adding device), and the detected magnification determination device 60 are implemented by a CPU 20 executing a control program stored in a ROM 22. A RAM 21 includes an area of a plurality of processing block buffers 21a, 21b, 21c, and 21d to store a plurality of magnification-changed images respectively.

Similar to a second embodiment, the processing block buffers 21a temporarily stores a magnification-changed image generated at a predetermined magnification (twice here) by the magnification converter 54a and the detection resolution converter 55a. The processing block buffers 21b temporarily stores a magnification-changed image generated at a predetermined magnification (an equal magnification here) by the magnification converter 54b and the detection resolution converter 55b. The processing block buffers 21c temporarily stores a magnification-changed image generated at a predetermined magnification (½ times here) by the magnification converter 54c and the detection resolution converter 55c. The processing block buffers 21d temporarily stores a magnification-changed image generated at a predetermined magnification (¼ times here) by the magnification converter 54d and the detection resolution converter 55d.

In a case where a size of data stored in each of two processing block buffers out of the processing block buffers 21a, 21b, 21c, and 21d reaches a predetermined size, the adder 59 generates a synthesized image by adding magnification-changed images stored in the two processing block buffers respectively.

The detection processing circuit 56 performs specific image detection processing for the generated synthesized image.

When the specific image detection processing for the synthesized image is completed, all of the data of the two magnification-changed images which are origins of the synthesized image are deleted from the processing block buffers, and a new magnification-changed image is stored in each of the two processing block buffers. The adder 59 generates a synthesized image by adding magnification-changed images stored in two processing block buffers every time the size of the data stored in each of the two processing block buffers reaches the predetermined size.

However, from the viewpoint of speeding up the specific image detection processing, one of the two magnification-changed images added by the adder 59 be constantly a magnification-changed image having a maximum magnification (twice here) among the plurality of magnification-changed images. The reason is that the magnification-changed image having the maximum magnification has the largest size and requires a time to detect the specific image.

In a case where the detection processing circuit 56 detects the specific image from the synthesized image, the detected magnification determination device 60 determines which one of the added two magnification-changed images includes the specific image by a determination method described below.

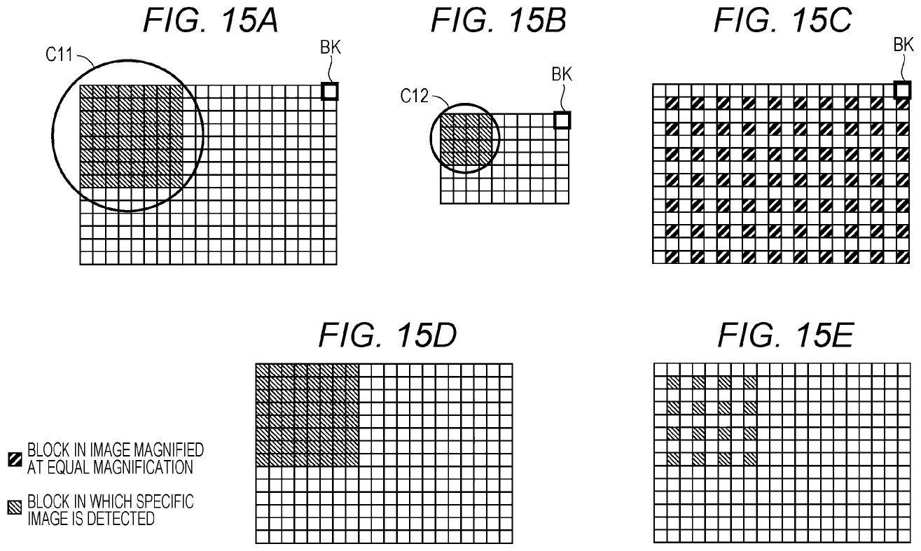

FIGS. 15A to 15E are diagrams to describe a method of determining a magnification of a magnification-changed image in which the specific image is detected in a case of detecting the specific image from a synthesized image obtained by adding an image magnified twice and an image magnified at an equal magnification in the third embodiment of the present invention.

Referring to FIGS. 15A to 15E, the number of blocks of the image magnified at the equal magnification (FIG. 15B) is fewer than the number of blocks of the image magnified twice (FIG. 15A). Therefore, the synthesized image of the image magnified twice and the image magnified at the equal magnification (FIG. 15C) is generated by dispersing, at equal intervals in the image magnified twice, respective blocks constituting the image magnified at the equal magnification, and superimposing the respective blocks thereof on respective blocks constituting the image magnified twice.

In a case where each of a plurality of blocks in an area C11 in the image magnified twice (FIG. 15A) includes the specific image, the specific image is detected from blocks consecutive to each other and corresponding to the area C11 in the synthesized image as illustrated in FIG. 15D. On the other hand, in a case where each of a plurality of blocks in an area C12 in the image magnified at the equal magnification (FIG. 15B) includes the specific image, the specific image is detected from blocks apart from each other in the synthesized image as illustrated in FIG. 15E.

Therefore, in a case where the blocks in each of which the specific image is detected are consecutive, it is determined that the image magnified twice includes the specific image, and it is determined that the magnification of the magnification-changed image in which the specific image is detected is twice. On the other hand, in a case where the blocks in each of which the specific image is detected are apart from each other, it is determined that the image magnified at the equal magnification includes the specific image, and it is determined that the magnification of the magnification-changed image in which the specific image is detected is the equal magnification.

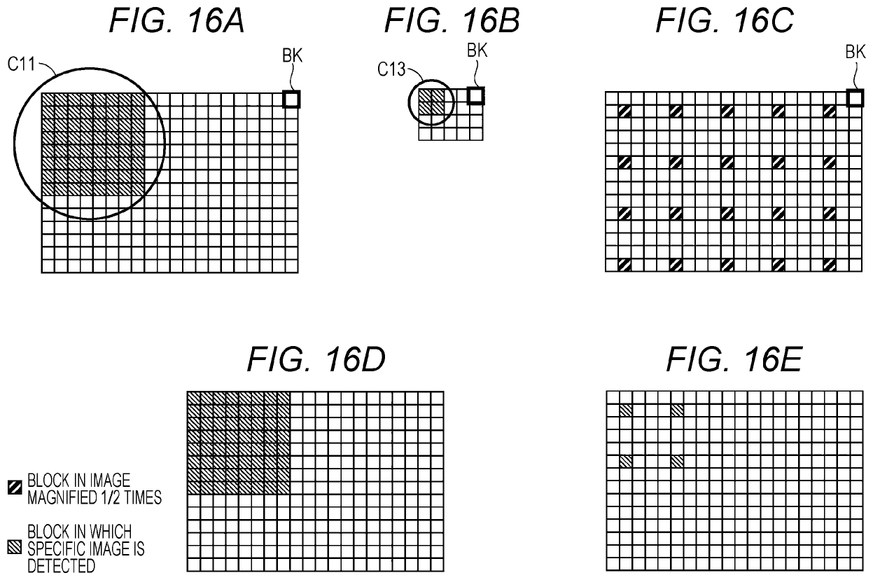

FIGS. 16A to 16E are diagrams to describe a method of determining a magnification of a magnification-changed image in which the specific image is detected in a case of detecting the specific image from a synthesized image obtained by adding an image magnified twice and an image magnified ½ times in the third embodiment of the present invention.

Referring to FIGS. 16A to 16E, the number of blocks of the image magnified ½ times (FIG. 16B) is fewer than the number of blocks of the image magnified twice (FIG. 16A). Therefore, the synthesized image of the image magnified twice and the image magnified ½ times (FIG. 16C) is generated by dispersing, at equal intervals in the image magnified twice, respective blocks constituting the image magnified ½ times, and superimposing the respective blocks thereof on respective blocks constituting the image magnified twice.

In a case where each of a plurality of blocks in an area C11 in the image magnified twice (FIG. 16A) includes the specific image, the specific image is detected from blocks consecutive to each other and corresponding to the area C11 in the synthesized image as illustrated in FIG. 16D. On the other hand, in a case where each of a plurality of blocks in an area C13 in the image magnified ½ times (FIG. 16B) includes the specific image, the specific image is detected from blocks apart from each other in the synthesized image as illustrated in FIG. 16E.

Therefore, in a case where the blocks in each of which the specific image is detected are consecutive, it is determined that the image magnified twice includes the specific image, and it is determined that the magnification of the magnification-changed image in which the specific image is detected is twice. On the other hand, in the case where the blocks in each of which the specific image is detected are apart from each other, it is determined that the image magnified ½ times includes the specific image, and it is determined that the magnification of the magnification-changed image in which the specific image is detected is ½ times.

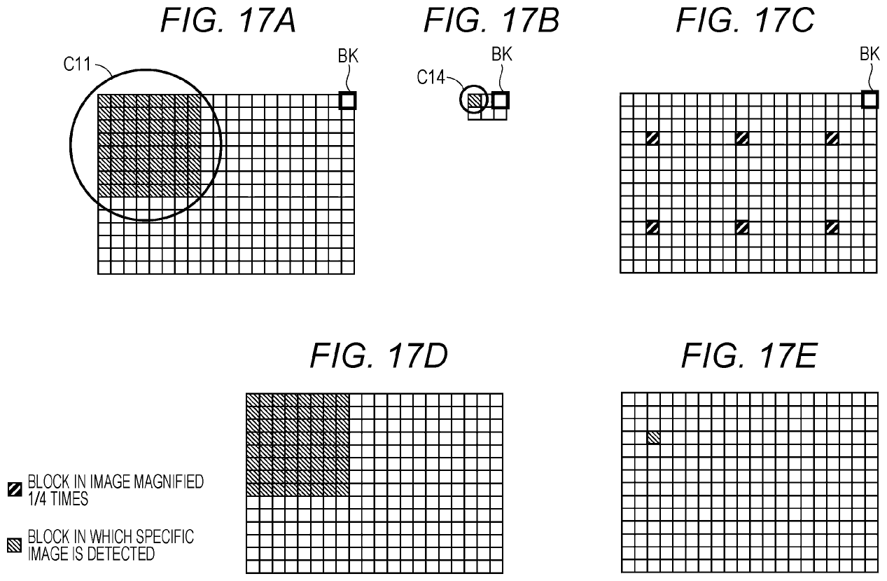

FIGS. 17A to 17E are diagrams to describe a method of determining a magnification of a magnification-changed image in which the specific image is detected in a case of detecting the specific image from a synthesized image obtained by adding an image magnified twice and an image magnified ¼ times in the third embodiment of the present invention.

Referring to FIGS. 17A to 17E, the number of blocks of the image magnified ¼ times (FIG. 17B) is fewer than the number of blocks of the image magnified twice (FIG. 17A). Therefore, the synthesized image of the image magnified twice and the image magnified ¼ times (FIG. 17C) is generated by dispersing, at equal intervals in the image magnified twice, respective blocks constituting the image magnified ¼ times, and superimposing the respective blocks thereof on respective blocks constituting the image magnified twice.

In a case where each of a plurality of blocks in an area C11 in the image magnified twice (FIG. 17A) includes the specific image, the specific image is detected from blocks consecutive to each other and corresponding to the area C11 in the synthesized image as illustrated in FIG. 17D. On the other hand, in a case where each of a plurality of blocks in an area C14 in the image magnified ¼ times (FIG. 17B) includes the specific image, the specific image is detected from blocks apart from each other in the synthesized image as illustrated in FIG. 17E.

Therefore, in a case where the blocks in each of which the specific image is detected are consecutive, it is determined that the image magnified twice includes the specific image, and it is determined that the magnification of the magnification-changed image in which the specific image is detected is twice. On the other hand, in the case the blocks in each of which the specific image is detected are apart from each other, it is determined that the image magnified ¼ times includes the specific image, and it is determined that the magnification of the magnification-changed image in which the specific image is detected is ¼ times.

To summarize the above-described determination method, in a case where blocks in each of which the specific image is detected are consecutive to each other, it is determined that a magnification-changed image having a relatively high magnification out of two magnification-changed images includes the specific image, and it is determined that the magnification of the magnification-changed image in which the specific image is detected is the relatively high magnification out of magnifications of the two magnification-changed images. On the other hand, in a case where blocks in each of which the specific image is detected are apart from each other, it is determined that a magnification-changed image having a relatively low magnification out of two magnification-changed images includes the specific image, and it is determined that the magnification of the magnification-changed image in which the specific image is detected is the relatively low magnification out of magnifications of the two magnification-changed images.

Referring to FIG. 14, the detected magnification determination device 60 associates (tags), with binarized data, the magnification of the magnification-changed image in which the specific image is detected, and stores the magnification in a print image memory inside the RAM 21.

On the other hand, in a case where the specific image is not detected from any one of the magnification-changed images by the detection processing circuit 56, the detected magnification determination device 60 does not tag a magnification of a magnification-changed image.

After that, the image forming apparatus 1 determines whether to restrict printing by performing processing similar to processing in a case of a first embodiment, and restricts printing as necessary.

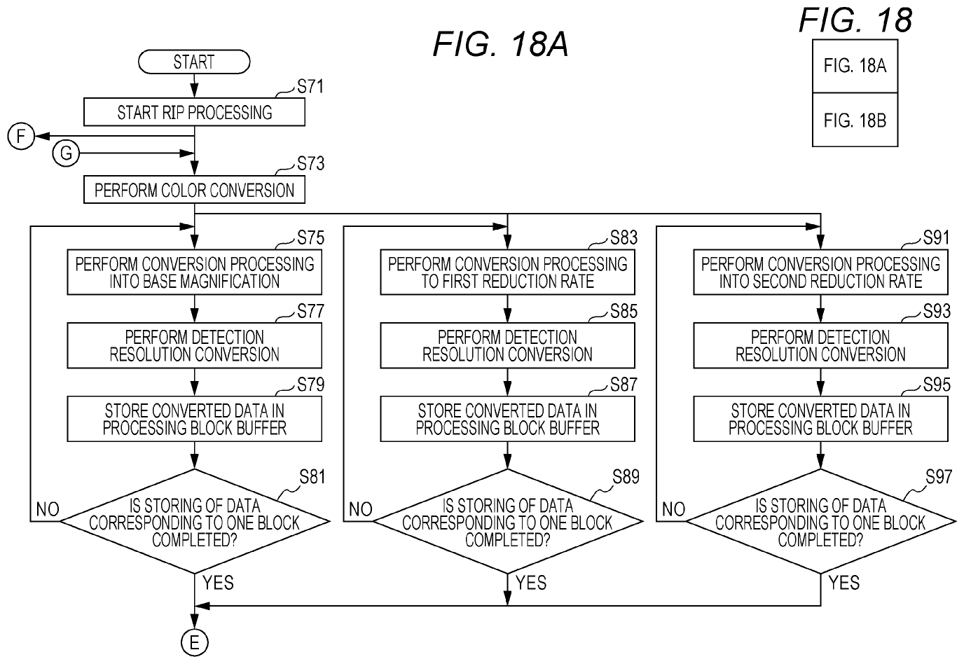

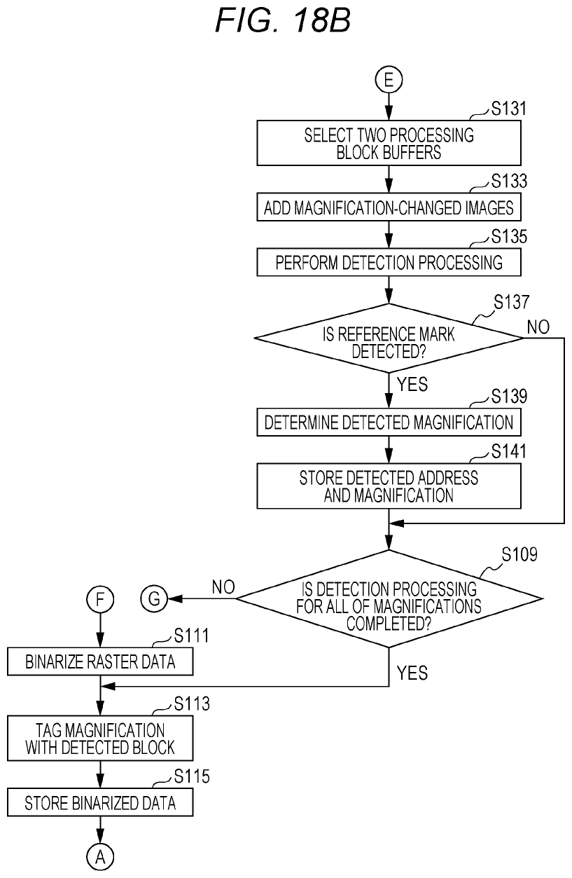

FIG. 18 is a flowchart illustrating operation of the image forming apparatus 1 according to the third embodiment of the present invention.

Referring to FIG. 18, the CPU 20 first performs processing in steps S71 to S97 of FIG. 11.

In at least two of steps S81, S89, and S97, in a case where it is determined that data corresponding to one block is stored in a processing block buffer (YES in S81, S89, or S97), the CPU 20 selects two processing block buffers determined to have stored the data corresponding to the one block (S131), and generates a synthesized image by adding two magnification-changed images stored in the selected processing block buffers (S133). Subsequently, the CPU 20 performs specific image detection processing for the synthesized image (S135), and determines whether a reference mark is detected from the synthesized image (S137).

In step S137, in a case of determining that the reference mark is detected from the synthesized image (YES in S137), the CPU 20 determines a magnification of a magnification-changed image in which the specific image is detected (S139). Next, the CPU 20 stores, in the RAM 21, a detected address (a place where the reference mark is detected in the magnification-changed image) and the magnification of the magnification-changed image (S141). After that, the CPU 20 performs processing from step S109 in FIG. 11.

Note that components and operation of the image forming apparatus 1 other than those described above are similar to those in the first embodiment, and therefore, a description thereof will not be repeated.

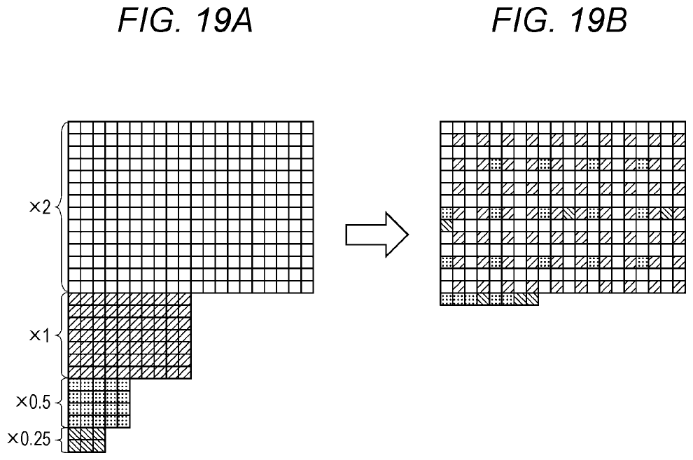

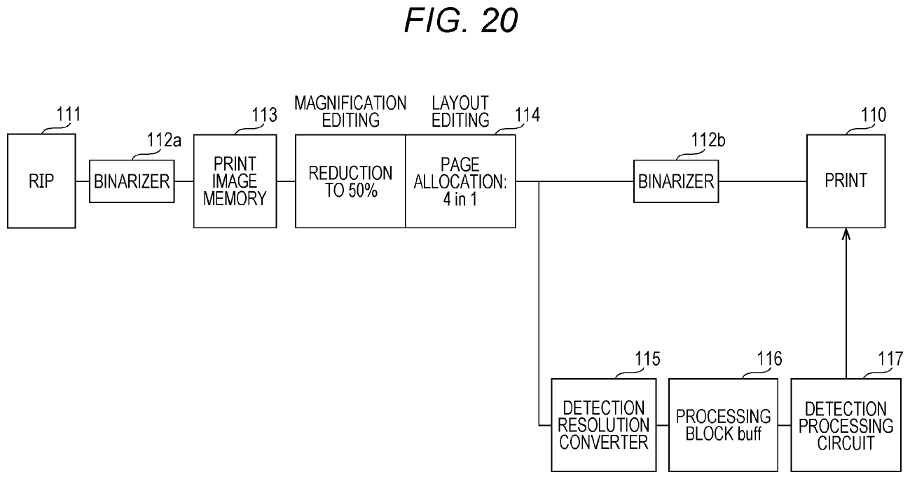

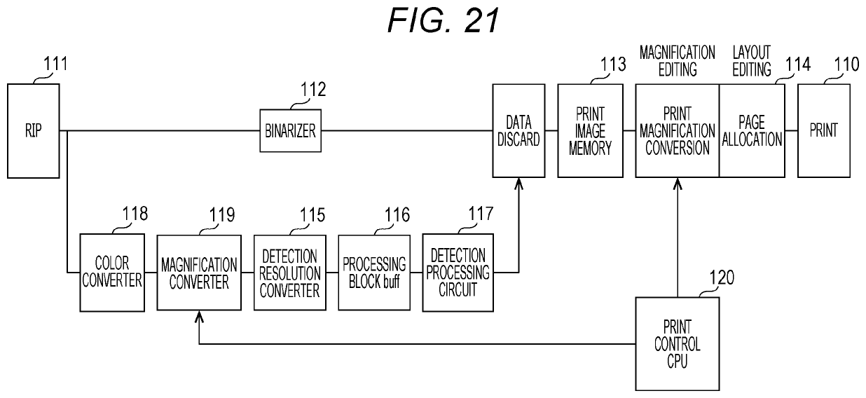

FIGS. 19A and 19B are diagrams conceptually illustrating processing order of the specific image detection processing performed in the third embodiment of the present invention. FIG. 19A is the diagram conceptually illustrating the processing order of the specific image detection processing for the magnification-changed image in the first embodiment. FIG. 19B is a diagram conceptually illustrating the processing order of the specific image detection processing performed in the third embodiment of the present invention.

Referring to FIGS. 19A and 19B, in the present embodiment, a synthesized image is generated by adding two magnification-changed images having different magnifications, and the specific image detection processing is performed for the synthesized image. In a case where the specific image is detected from the synthesized image, from which one of the two magnification-changed images the specific image is detected is determined based on presence/absence of consecutiveness of blocks in each of which the specific image is detected. Consequently, it is possible to reduce the number of blocks to be processing targets of the specific image detection processing, and a time required for the specific image detection processing can be shortened.

[Others]

In a case where the image forming apparatus 1 detects a specific image, printing may be uniformly restricted regardless of a preset printing condition. Consequently, printing can be restricted even in a case where a received job is a job in which a magnification to be set in additional edit operation is not determined yet, such as a job to store, in a box of the hard disk 23H, data subjected to the RIP processing.

Moreover, the processing in the above-described embodiments may be performed by software or by using a hardware circuit. Additionally, a program to execute the processing in the above-described embodiments can be provided, and the program may be provided to a user by recording the program in recording media such as a CD-ROM, a flexible disk, a hard disk, a ROM, a RAM, and a memory card. The program is executed by a computer such as a CPU. Furthermore, the program may be downloaded in a device via a communication line such as the Internet.

Although embodiments of the present invention have been described and illustrated in detail, the disclosed embodiments are made for purposes of illustration and example only and not limitation. The scope of the present invention should be interpreted by terms of the appended claims as well as all of changes within the scope of the claims.

What is claimed is:

1. An image processing apparatus comprising:
a receiver that receives image data;
a magnification changer that generates each of a plurality of magnification-changed images by magnifying the image data at a plurality of magnifications different from each other;
a detector that detects a specific image from the plurality of magnification-changed images; and
a hardware processor that restricts printing of the image data under a part of printing conditions in a case where the specific image is detected by the detector.

2. The image processing apparatus according to claim 1, further comprising
an image memory that stores the image data binarized,
wherein the magnification changer generates each of the plurality of magnification-changed images based on the image data before binarization.

3. The image processing apparatus according to claim 2, wherein in a case where the specific image is detected from one magnification-changed image by the detector, the hardware processor restricts printing of the image data at a magnification within a predetermined range determined based on a magnification of the one magnification-changed image.

4. The image processing apparatus according to claim 3, further comprising:
a magnification storage device that stores the magnification of the one magnification-changed image in the image memory in a manner associated with the binarized image data in the case where the specific image is detected from the one magnification-changed image by the detector; and
an additional edit receiver that receives edit operation to change a magnification of the image data after detection of the specific image by the detector is finished,
wherein in a case where a product of a magnification preset in the image data and a magnification for magnification change received by the additional edit receiver is a magnification within the predetermined range determined based on the magnification of the one magnification-changed image stored in the image memory, the hardware processor restricts printing under a printing condition in accordance with the edit operation received by the additional edit receiver.

5. The image processing apparatus according to claim 4,
wherein a magnification at the time of generating each of the plurality of magnification-changed images by the magnification changer is a magnification that can be set as the printing condition, and
the additional edit receiver does not receive edit operation to change the magnification of the image data to a magnification different from the magnification at the time of generating each of the plurality of magnification-changed images by the magnification changer.

6. The image processing apparatus according to claim 2, wherein in a case where the specific image is detected by the detector, the hardware processor restricts printing of the image data regardless of the printing condition.

7. The image processing apparatus according to claim 2, wherein the hardware processor stops printing, and restricts printing by deleting the binarized image data from the image memory.

8. The image processing apparatus according to claim 1, wherein in a case where the specific image is detected from a certain magnification-changed image among the plurality of magnification-changed images, the detector partly continues detection of the specific image from the magnification-changed image from which the specific image is detected among the plurality of magnification-changed images.

9. The image processing apparatus according to claim 1, further comprising
a plurality of buffers to store the plurality of magnification-changed images respectively,
wherein the magnification changer includes:
a resolution changer that changes a resolution of each of the plurality of magnification-changed images to a predetermined resolution; and
a buffering device that temporarily stores, in each of the plurality of buffers, each of the plurality of magnification-changed images subjected to the resolution change, and
the detector detects the specific image from each of the plurality of magnification-changed images stored in each of the plurality of buffers.

10. The image processing apparatus according to claim 9, further comprising
a switcher that selectively switches a buffer to be a detection target among the plurality of buffers,
wherein the detector detects the specific image from a magnification-changed image stored in a buffer that is set as the detection target by the switcher.

11. The image processing apparatus according to claim 10,
wherein the switcher sets, as a detection target, a buffer in which a size of stored data reaches a predetermined size among the plurality of buffers, and
in a case where there are two or more buffers in each of which a size of stored data reaches the predetermined size among the plurality of buffers, the switcher preferentially sets, as the detection target, a buffer in which a magnification-changed image having a relatively high magnification for magnification change is stored.

12. The image processing apparatus according to claim 11, further comprising
an adding device that adds magnification-changed images stored in two buffers respectively in a case where a size of data stored in each of the two buffers reaches the predetermined size among the plurality of buffers,
wherein the detector detects the specific image from a synthesized image obtained by adding the magnification-changed images by the adding device, and
the image processing apparatus further comprises a determination device that determines which one of the two magnification-changed images added by the adding device includes the specific image, based on presence/absence of consecutiveness of blocks in each of which the specific image is detected in a case where the specific image is detected by the detector.

13. The image processing apparatus according to claim 12, wherein one magnification-changed image out of two magnification-changed images to be added by the adding device is a magnification-changed image having a maximum magnification among the plurality of magnification-changed images.

14. A non-transitory recording medium storing a computer readable control program causing a computer to perform:
receiving image data;
generating each of a plurality of magnification-changed images by magnifying the image data at a plurality of magnifications different from each other;
detecting a specific image from the plurality of magnification-changed images; and
restricting printing of the image data under at least a part of printing conditions in a case where the specific image is detected in the detecting.
